(19) United States
(12) Patent Application Publication
(10) Pub. No.: US 2017/0072477 A1
(43) Pub. Date: Mar. 16, 2017

(54) PARTIALLY HARDENED ROTARY TOOL AND CORRESPONDING PRODUCTION METHOD

(71) Applicant: GÜHRING KG, Albstadt (DE)

(72) Inventors: Jochen BITZER, Albstadt (DE); Steffen LANG, Albstadt (DE)

(73) Assignee: GÜHRING KG, Albstadt (DE)

(21) Appl. No.: 15/271,307

(22) Filed: Sep. 21, 2016

Related U.S. Application Data
(63) Continuation of application No. PCT/DE2015/000128, filed on Mar. 20, 2015.

(30) Foreign Application Priority Data
Mar. 21, 2014 (DE) 10 2014 103 906.8

(51) Int. Cl. B23B 51/06; C21D 1/10; B23B 51/02; C21D 9/22

(52) U.S. Cl. CPC B23B 51/06; C21D 9/22; C21D 1/10; B23B 51/02; C21D 2221/01; B23B 2228/24; B23B 2250/12

(57) ABSTRACT

A rotary tool for machining workpieces, comprising at least one main body with a clamping segment, a tool head comprising a cutting region, and at least one coolant channel for feeding a cooling and lubricating fluid into the cutting region. At least one partial surface section of the cutting region forms a hardened region, which covers and/or defines the coolant channel and is surface-hardened. A method for producing a rotary tool.

The invention pertains to a rotary tool for machining workpieces, which comprises a main body with a clamping segment and a tool head featuring a cutting region with at least one cutting edge. The tool head also features at least one cooling channel for feeding a cooling and lubricating fluid into the cutting region. The invention furthermore pertains to a method for producing a corresponding rotary tool.

### PRIOR ART

A wide variety of rotary tools comprising a main body with a clamping segment and a tool head are known from the prior art. The clamping segment may consist of a clamping shaft or a specially shaped axial end region of the rotary tool, which is designed for being accommodated in a special clamping device, e.g. an HSK clamping device, and typically arranged on the end region of the drilling tool lying axially opposite of the tool shaft. In a number of rotary tools, the metallic material of the tool head is hardened in order to meet the high mechanical demands of a machining process. Such rotary tools may consist of drilling, reaming, milling or polishing tools. The tool head of such rotary tools typically features at least one cutting edge, by means of which material is removed from a workpiece in a machining process. Especially high-performance rotary tools such as, for example, HPC (High Performance Cutting) or HSC (High Speed Cutting) tools are provided with one or more cooling channels for feeding a cooling or lubricating fluid into the region of the tool head in order to thereby cool the tool head and its cutting edge and to remove material cuttings from the cutting region.

The service life and the functionality of a rotary tool are typically improved by hardening the tool head in order to increase its mechanical strength. This is achieved by changing or transforming the metal structure of the tool head by means of a heat treatment and subsequent quenching. In this case, the entire tool head is usually hardened in order to achieve the desired strength.

DE 10 2011 000 793 A1 discloses a self-sharpening drilling tool, in which a tool head of a main body has a first, lesser hardness and a coating with a second, greater hardness. The coating serves for realizing a purposeful abrasion of the main cutting edge in order to thereby achieve a self-sharpening effect of the drilling tool. It is proposed that the hard coating consists, for example, of a ceramic coating that is once again removed mechanically at selected locations in order to expose regions of lesser hardness. This publication consequently proposes a rotary tool that is provided with a hardenable coating on the tool head, wherein sections of the harder coating are once again removed in a subsequent production step in order to purposefully provide hardened regions with a different hardness in the tool head. The harder coating of the tool head serves for achieving a self-sharpening effect of the rotary tool. This publication does not disclose a drilling tool with a coolant channel.

In the processing of aluminum and soft metals with high silicone content, a rotary tool is subjected to significant wear due to the toughness of the workpiece to be processed. Especially thin-wall surfaces in the tool head of a rotary tool, which define a cooling channel, are therefore stressed mechanically and thermally such that they thin away and wear out after prolonged use of the rotary tool. This means that especially the wall regions around a cooling channel and around an outlet nozzle of the cooling channel can fracture such that the mechanical stability of the rotary tool, the lubricating capacity and the service life are limited. The invention therefore is based on the objective of proposing a rotary tool and the corresponding production method, which allow the long-term use and a high processing quality, in particular, of aluminum materials with high silicone content and other soft-metallic and tough materials.

This objective is attained with a rotary tool and a production method according to the independent claims. Advantageous enhancements of the invention form the objects of the dependent claims.

### DISCLOSURE OF THE INVENTION

The invention concerns a rotary tool for machining workpieces, which comprises a main body with a clamping segment and a tool head featuring a cutting region with at least one cutting edge. The tool head also features at least one coolant channel for feeding a cooling and lubricating fluid into the cutting region. It is proposed that at least a partial surface section of the cutting region forms a hardened region that covers and/or defines the coolant channel and is surface-hardened. The inventive rotary tool therefore is surface-hardened in the peripheral sections of the coolant channel such that thin webs between the outer surface of the tool head and the cooling channel have a greater hardness than the remaining metallic regions of the tool head. The surface-hardened region may have a hardness similar to that of cutting edges or cutting dies of the tool head, but always has a greater hardness than a surface area of a flute or a circumferential section of the tool head. This type of partial surface hardening can be achieved with a selective hardening process. In the hardened region, the thin outer layer of the tool head is transformed into martensite in order to provide a tough and durable periphery of the cooling channel. Partial surface sections with any contour shape can thereby be surface-hardened. In this way, cooling channels can be purposefully routed to surface areas of the tool head, which need to be cooled and lubricated and are only surrounded by small material thicknesses. Consequently, an improved cooling effect can be achieved and a high sturdiness of the rotary tool can be ensured.

In an advantageous embodiment, an essentially round or elliptical hardened region may be formed concentrically around a cooling channel outlet nozzle on an end face or lateral face, particularly in a flute of the cutting region. The hardened regions particularly may be arranged around the cooling fluid outlets such that the coolant can be discharged from the coolant channel at exposed locations, at which high mechanical loads and thermal stresses occur. The regions of the tool head located directly adjacent to the outlet nozzle may be surface-hardened in order to increase the sturdiness and the mechanical stability of the tool head in the region around the coolant channel outlet.

According to another advantageous embodiment of the invention, an essentially elongate and strip-shaped hardened region, which follows the coolant channel in the interior of the tool head and covers the coolant channel, may be formed, particularly along a flute. In this way, a surface area covering the coolant channel can be realized in the form of a hardened region in order to mechanically reinforce a relatively thin material cover of the coolant channel and to increase its thermal stability. In many instances, the coolant channel extends along a flute in the direction of the center of the rotary tool, wherein relatively thin material covers are provided between the cooling channel and the outer surface of the flute, particularly in the direct vicinity of the coolant channel outlet nozzle. If such elongate and, in particular, strip-shaped regions are hardened by means of a selective surface hardening process, the risk of a fracture or material wear is significantly reduced and the sturdiness of the tool head is increased.

The hardened region can be formed in a particularly advantageous fashion by selectively austenitizing the outer layer of the surface material in the cutting region. This austenitizing of the outer layer is realized with a surface hardening process, which is also referred to as case hardening and used for hardening the outer layers of metallic components. In this case, only thin surface areas of the outer layer are austenitized, wherein the high toughness of the starting material persists in the interior of the workpiece such that the elasticity and flexibility of the material are not impaired. However, the surface is realized in a hard and wear-resistant fashion such that the vibration fatigue limit and the pressure resistance of the tool head are preserved. Nevertheless, the rigidity is increased and the wear resistance is improved, particularly in the hardened region.

In a particularly advantageous embodiment, the selective austenitizing of the outer layer is realized by means of laser beam hardening, electron beam hardening, ion beam hardening or induction hardening. The surface hardening is advantageously realized with a selective hardening process, particularly electron beam hardening or ion beam hardening or laser beam hardening. Hardened regions with extremely small surface areas and shallow depths can be produced with laser beam and electron beam hardening, as well as with ion beam hardening, wherein a high-energy laser beam, electron beam or ion beam directed at the partial surface areas causes the surface material to be quickly heated to the austenitizing temperature in certain spots. A subsequent quenching process makes it possible to achieve the desired hardening. In electron beam and ion beam hardening, this is carried out under a vacuum atmosphere such that a vacuum processing step is required. In laser beam hardening, the partial surface areas can be selectively hardened under an air atmosphere. In induction hardening, the surface areas are exposed to an alternating magnetic field in order to generate locally defined eddy currents, which in turn make it possible to locally heat and subsequently harden the surface areas. Induction hardening has a lower spot precision than laser beam, ion beam or electron beam hardening processes and is particularly suitable for large hardened regions of voluminous drilling tools. However, the technical effort for an induction hardening system is lower than for the above-described beam hardening processes.

It is particularly preferred to utilize laser beam hardening for increasing the sturdiness of the surface areas of the coolant channel. In this way, the expansion of the hardened regions can be precisely controlled with a relatively short time interval of the energy input under an air atmosphere. A diode laser, in particular, may be used instead of a CO₂ laser because the shorter wavelength of the diode laser, which lies close to an infrared wavelength, is absorbed much better in drill steel than the higher wavelength of a CO₂ laser. On the other hand, the electrical efficiency and the service life of a diode laser are clearly superior to that of a CO₂ laser, particularly when it is used in mass production, and therefore result in reduced production times and production costs. The above-described selective surface hardening processes make it possible to precisely harden or post-harden the exact contour of wear-prone regions of the tool head, particularly peripheries of the coolant channel, in comparison with the surrounding tool material. Due to the rapid heat input and practically simultaneous self-quenching, short hardening times and therefore a high production speed can be achieved in the production of rotary tools with partial hardened regions of the material surfaces covering the coolant channels.

According to a coordinate aspect of the invention, a method for producing a rotary tool is proposed, wherein at least one partial surface section of the cutting region of the tool head is during or after the production of the rotary tool from a main body subjected to a selective surface hardening process, in which a surface section that covers and/or defines a coolant channel of the rotary tool is surface-hardened in order to form the at least one hardened region. The method therefore represents a modification of a conventional production method for a rotary tool, according to which a selective surface hardening step is already carried out during the production of the rotary tool or after the production of the rotary tool has been completed in order to surface-harden partial surface areas that define the coolant channel of the rotary tool.

It is preferred to use a case hardening process in the form of laser beam hardening, electron beam hardening, ion beam hardening or induction hardening for carrying out the partial surface hardening step. The aforementioned methods, particularly laser beam hardening, make it possible to purposefully harden selected surface areas of the tool head in order to flexibly harden partial surface areas in different and complex geometries of the rotary tool and to thereby achieve a high surface hardness of regions that cover coolant channels and may be thin-walled. In this way, a plurality of coolant channels can be provided and the cooling fluid can be fed to particularly stressed areas such that the sturdiness of the rotary tool and the cooling capacity can be significantly improved. This in turn makes it possible to achieve an improved fluid lubrication, particularly an improved MQL (minimal quantity lubrication), wherein thin-walled cooling channels with outlet nozzles can be provided near the cutting edges to be lubricated.

It is advantageous to move the rotary tool to be partially surface-hardened relative to a selective hardening device in order to thereby austenitize the partial surface area. In this context, it is proposed that either the rotary tool is moved relative to a laser beam source, electron beam source or ion beam source or relative to a field coil of an induction hardening system or that the hardening device is moved relative to the rotary tool in order to case-harden the partial surface areas. It is usually advantageous to move the rotary tool, which has a small mass and free mobility, relative to a stationary hardening device in order to selectively austenitize the partial surface areas.

### DRAWINGS

Other advantages can be gathered from the following description of the drawings. These drawings show exemplary embodiments of the invention. The drawings, the description and the claims contain numerous characteristics in combination. For practical purposes, however, a person skilled in the art will also consider these characteristics individually and form other sensible combinations thereof.

In the drawings:

FIG. 1 schematically shows a tool head according to an exemplary embodiment of an inventive rotary tool with hardened regions;

FIG. 2 shows a perspective view of another exemplary embodiment of a rotary tool with hardened regions;

FIG. 3 shows a top view of an end face of a tool region of another exemplary embodiment of a rotary tool;

FIG. 4 shows a perspective view of an exemplary embodiment of a rotary tool with partially hardened surface areas;

FIG. 5 shows a perspective view of a deep hole rotary tool according to an exemplary embodiment of the invention;

FIG. 6 shows another deep hole rotary tool according to an exemplary embodiment of the invention; and

FIG. 7 shows a perspective view of another exemplary embodiment of a rotary tool according to the invention.

In these figures, identical or similar components are identified by the same reference symbols.

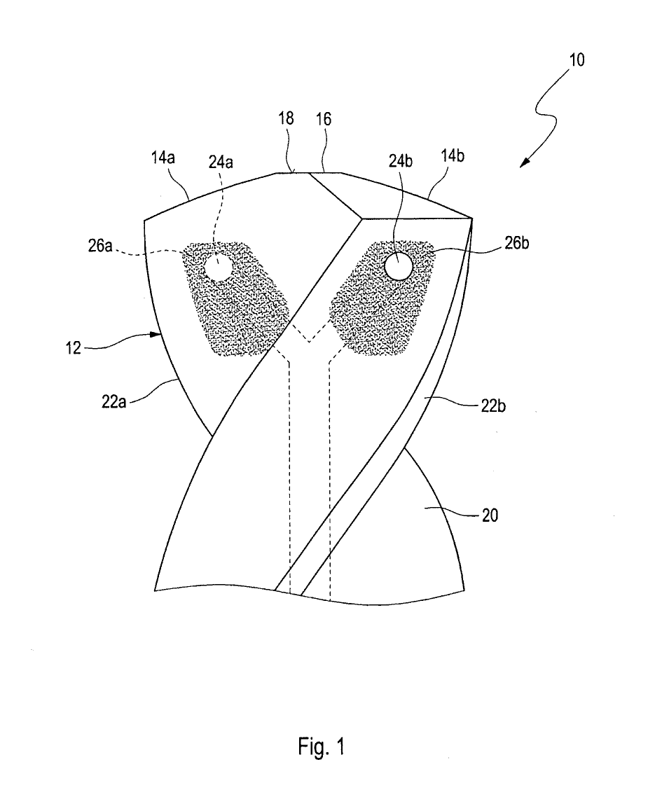

FIG. 1 shows a tool head 12 of a rotary tool 10. The tool head 12 comprises two primary cutting edges 14a and 14b, which are connected to one another by a cross edge 16. A flute 20 extends between the two primary cutting edges 14a, 14b and separates the flanks of the cutting edges 14a, 14b from one another. The flute 20 is defined by secondary cutting edges of the cutting phase 22a, 22b. Outlet regions of coolant channels 24a (drawn with broken lines) and 24b, which branch off a main coolant channel extending along the axis of the rotary tool 10, are respectively recessed into the flute surfaces. The first flank in the concentric surface area around the outlets 24a, 24b is respectively realized in the form of a hardened region 26a and 26b with a locally hardened surface in order to prevent the relatively thin material wall between the surface area and the respective coolant channel 24a, 24b from fracturing under high thermal and mechanical stress. The respective hardened region 26a, 26b can be selectively heated, for example by means of a laser hardening process, and subsequently quenched in order to increase its hardness in comparison with the remaining regions of the tool head 12.

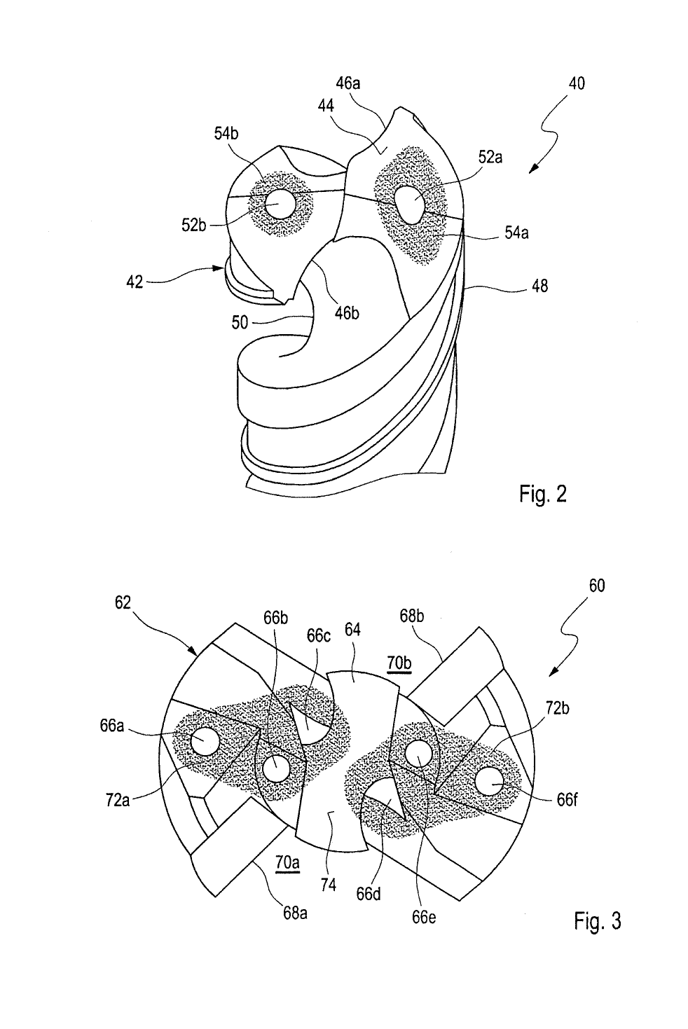

FIG. 2 shows a perspective view of another drilling tool 40 that is realized in the form of a reaming tool. The tool head 42 of the reaming tool 40 comprises two primary cutting edges 46a and 46b for reaming a sunk bottom of a workpiece. Outlet regions of coolant channels 52a and 52b are respectively arranged on the end face 44 in order to cool the primary cutting edge 46 and to remove chips. The hardened regions 54 are respectively arranged concentrically around the outlet regions 52a and 52b in order to prevent the relatively thin material wall from fracturing under high mechanical and thermal stress. The coolant channels 52a and 52b are routed along the wall formed by a helicoidal flute 50. A secondary cutting edge 48 along the flank of the outer walls of the reaming tool 40 serves for reaming a drill hole and for polishing the workpiece surface within the recess being produced.

FIG. 3 shows a tool head 62 of a PCD drilling tool 60. Two PCD edges 68a and 68b, which respectively border on flutes 70a and 70b, are arranged on the point section 64 of the tool head 62. Several coolant channel outlets 66a-66f are arranged on the end face 74 and can discharge a lubricating and cooling fluid in different directions of the end face 74 in order to thereby achieve an effective chip transport via the flutes 70 and to cool the tool head 62. Groups of three coolant channel outlets 66a, 66b, 66c and 66e, 66d, 66f are respectively combined within common hardened regions 72a and 72b, which are defined concentrically around the outlets 66 and respectively reinforce the surface area around the outlets 66 of the coolant channel in order to thereby increase the sturdiness of the PCD tool head 62. The regions 72 around the coolant channels 66, which are reinforced by means of case hardening, prevent fracturing under high thermal and mechanical stress.

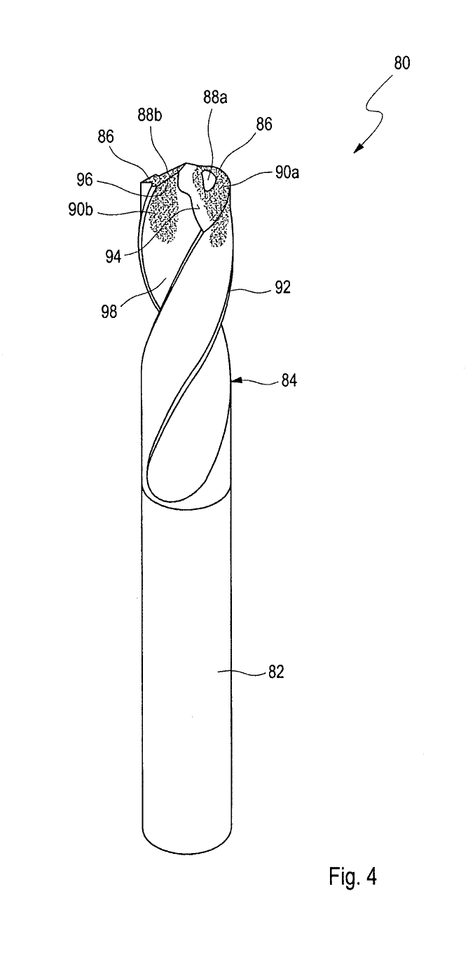

FIG. 4 shows another exemplary embodiment of a drilling tool 80 in the form of a perspective view. The drilling tool 80 comprises a clamping segment 82 in the form of a shaft and a tool head 84, which carries several cutting edges 96 and a coiled bezel 92 that forms the periphery of a flute 98. The cutting edges 96 are arranged on an end face 94 of the tool head 84. Two coolant channels 88a, 88b feature contoured outlets on the end face 94. The outlets are separated from the circumferential surface of the tool head 84 by webs 86. Elliptical hardened regions 90 are arranged concentrically around the outlets of the coolant channels 88a, 88b. Additional strip-shaped hardened regions, which are drawn with broken lines, are provided along the flute 98 and define the relatively thin material wall between the respective coolant channel 88a, 88b and the flute surface 98.

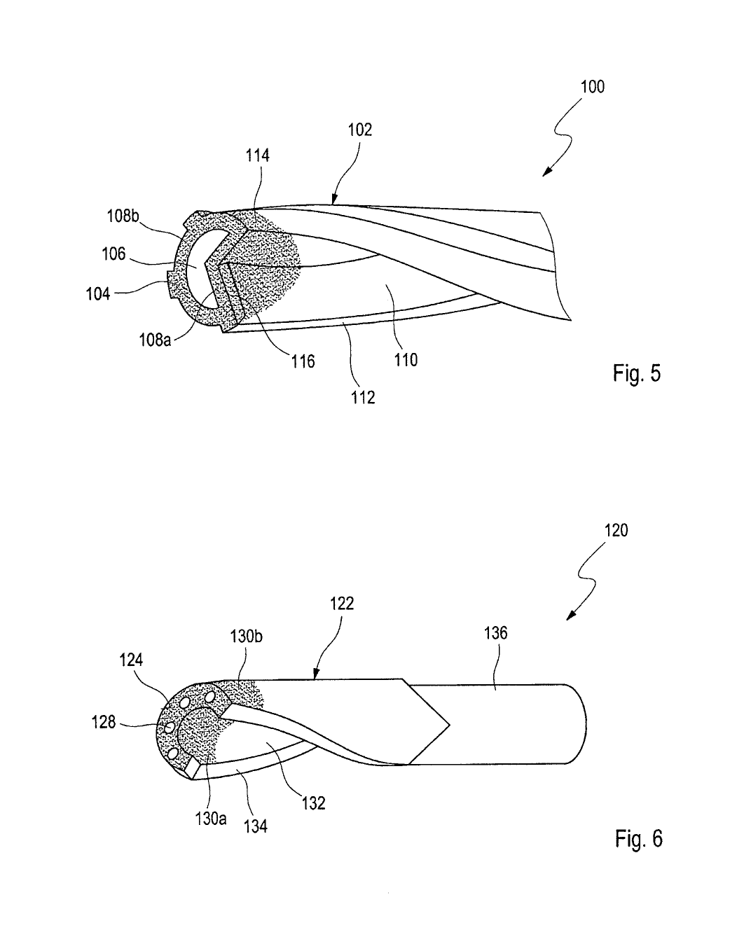

FIGS. 5 and 6 show two different embodiments of deep hole drills 100 and 120. Each deep hole drill 100, 120 features a clamping segment 136 in the form of a hollow shaft and a respective tool head 102 and 122. Each tool head 102, 122 comprises a bezel cutting edge 112, 134 and respectively features a coolant channel outlet 106 or several coolant outlet nozzles 128, which supply cooling fluid for cooling the tool head and for removing chips from respective head cutting edges 116 and 138, on its end face 104, 124. Chips are removed in respective flutes 110 and 132 that can be flushed with the lubricating and cooling fluid. On the peripheral edge of the end face 104, the deep hole drill 100 features stabilizing webs 108a and 108b on its surface area. A not-shown inlet of the coolant channel is provided in the hollow shaft 136 of the deep hole drill 120 on the clamping end. Hardened regions 114 and 130a, 130b are respectively arranged on the end faces 104, 124 of the tool heads 102, 122, which comprise the coolant channel outlet nozzles 128 of the respective coolant channels 106 and 128, and cover the corresponding end face 104, 124 and at least a strip-shaped region of the respective flutes 110 and 132. A deep hole is additionally cut out and widened by means of respective bezel cutting edges 112 and 134 that define the flutes 110, 132.

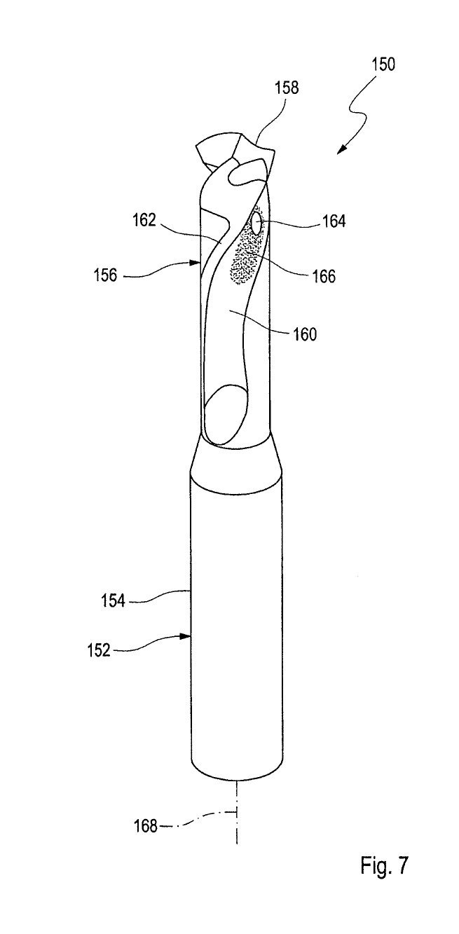

FIG. 7 ultimately shows a perspective view of another exemplary embodiment of a rotary tool 150 with a partially hardened surface area for protecting a coolant channel 164. The rotary tool 150 comprises a main body 152, which has an axis 168 and forms a clamping segment 154 in the form of a shaft and a tool head 156. A head cutting edge 158, as well as a flute 160, is provided in the tool head 156. The flute 160 is defined by a bezel cutting edge 162. An outlet of a coolant channel 164 is located in the flute 160, wherein said outlet is surrounded by an elongate, strip-shaped hardened region 166 that reinforces the wall between the flute 160 and the coolant channel 164 in order to increase the sturdiness of the rotary tool 150.

Significant wear of a drilling tool can occur, in particular, in the processing of aluminum materials with a higher silicone content such that undesirable fracturing of a cooling channel wall can occur. In order to prevent such fractures, the regions of the tool head that cover the coolant channel can be hardened by means of a selective surface hardening process, particularly laser beam hardening. A selective hardening process has the advantage that selected regions can be hardened in order to thereby flexibly protect partial surface areas of the tool head against mechanical wear. Especially laser beam hardening, as well as electron beam hardening and ion beam hardening, or even an inductive hardening process may be used in this case.

### LIST OF REFERENCE SYMBOLS

10 Rotary tool
12 Tool head
14 Primary cutting edge
16 Cross edge
18 End face
20 Flute
22 Secondary cutting edge
24 Coolant channel
26 Hardened region
28
30
32
34
36
38
40 Reaming tool
42 Tool head
44 End face
46 Primary cutting edge
48 Secondary cutting edge/cutting bezel
50 Flute
52 Cooling channel
54 Hardened region
56
58
60 PCD drilling tool
62 Tool head
64 Point section
66 Cooling channel
68 PCD edges
70 Flute
72 Hardened region
74 End face
76
78
80 Drilling tool
82 Shaft, clamping segment
84 Tool head
86 Web
88 Coolant channel with contoured outlet
90 Hardened region
92 Bezel
94 End face
96 Cutting edge
98 Flute
100 Deep hole drill
102 Tool head
104 End face
106 Cooling channel
108 Web
110 Flute
112 Bezel cutting edge
114 Hardened region
116 Head cutting edge
118
120 Deep hole drill
122 Tool head
124 End face
128 Coolant outlet nozzle
130 Hardened region
132 Flute
134 Bezel cutting edge
136 Hollow shaft
138 Head cutting edge
140
142
144
146
148
150 Drilling tool
152 Main body
154 Shaft, clamping segment
156 Tool head
158 Head cutting edge
160 Flute
162 Bezel cutting edge
164 Coolant channel
166 Hardened region
168 Tool axis

1. A rotary tool for machining workpieces, comprising a main body with a clamping segment and a tool head comprising a cutting region with at least one cutting edge, the tool head further comprising at least one coolant channel for feeding a cooling and lubricating fluid into the cutting region, at least a partial surface section of the cutting region forming a hardened region that covers and/or defines the coolant channel and is surface-hardened.

2. The rotary tool according to claim 1, wherein an essentially round or elliptical hardened region is formed concentrically around a cooling channel outlet nozzle on an end face or lateral face, of the cutting region.

3. The rotary tool according to claim 1, wherein the rotary tool comprises an essentially elongate and strip-shaped hardened region, which follows the coolant channel in the interior of the tool head and covers the coolant channel.

4. The rotary tool according to claim 1, wherein the hardened region is formed by selectively austenitizing the outer layer of a surface material in the cutting region.

5. The rotary tool according to claim 4, wherein the austenitizing of the outer layer is realized by means of laser beam hardening, electron beam hardening, ion beam hardening or induction hardening.

6. A method for producing a rotary tool according to claim 1, wherein at least one partial surface section of the cutting region of the tool head is, during or after the production of the rotary tool from a main body, subjected to a selective surface hardening process, in which a surface section that covers and/or defines a coolant channel of the rotary tool is surface-hardened in order to form the at least one hardened region.

7. The method according to claim 6, wherein a case hardening process in the form of laser beam hardening, electron beam hardening, ion beam hardening or induction hardening is used for carrying out the partial surface hardening step.

8. The method according to claim 6, wherein the rotary tool to be partially surface-hardened is moved relative to a selective hardening device in order to thereby austenitize the partial surface area into the hardened region.

9. The rotary tool according to claim 1, wherein an essentially round or elliptical hardened region is formed concentrically around a cooling channel outlet nozzle in a flute of the cutting region.

10. The rotary tool according to claim 1, wherein an essentially elongate and strip-shaped hardened region, which follows the coolant channel in the interior of the tool head and covers the coolant channel is formed along a flute.
